(19) United States
(12) Patent Application Publication
(10) Pub. No.: US 2024/0304433 A1
(43) Pub. Date: Sep. 12, 2024

(54) Feedback Control Of High-Vaccum Cold-Ion Sources Using Rydberg Atom Spectroscopy

(71) Applicants: THE REGENTS OF THE UNIVERSITY OF MICHIGAN, Ann Arbor, MI (US); Rydberg Technologies Inc., Ann Arbor, MI (US)

(72) Inventors: David ANDERSON, Ann Arbor, MI (US); Alisher DUSPAYEV, Ann Arbor, MI (US); Georg RAITHEL, Ann Arbor, MI (US)

(73) Assignees: THE REGENTS OF THE UNIVERSITY OF MICHIGAN, Ann Arbor, MI (US); Rydberg Technologies Inc., Ann Arbor, MI (US)

(21) Appl. No.: 18/599,629

(22) Filed: Mar. 8, 2024

Related U.S. Application Data
(60) Provisional application No. 63/451,266, filed on Mar. 10, 2023.

(51) Int. Cl. H01J 49/16; G02F 1/11; H01J 49/42

(52) U.S. Cl. CPC H01J 49/161; G02F 1/113; H01J 49/4225; H01J 49/426

(57) ABSTRACT

A method is presented for generating an ion beam. The method includes: positioning atoms in a cavity of an optical resonator that defines an optical dipole trap; exciting the atoms while the atoms are trapped in the optical dipole trap using two or more laser beams, thereby forming ions; and driving the ions along an output axis towards a target by applying an electric field to the ions. In one aspect, the ion density of the ion source is regulated, for example using feedback control. Changing the ion density may be achieved, for example by inputting the atomic excitation spectrum into a feedback loop and controlling the power of the two or more laser beams using feedback from the feedback loop.

### CROSS-REFERENCE TO RELATED APPLICATIONS

This application claims the benefit of U.S. Provisional Application No. 63/451,266, filed on Mar. 10, 2023. The entire disclosure of the above application is incorporated herein by reference.

### GOVERNMENT CLAUSE

This invention was made with government support under 2110049 awarded by the National Science Foundation and DE-SC0023090 awarded by the U.S. Department of Energy. The government has certain rights in the invention.

### FIELD

The present disclosure relates to cold ion sources.

### BACKGROUND

The use of atomic probes and related methods in laser-generated, small laboratory plasmas, both in cold atom environments as well as in room-temperature atomic vapors, is an area of research of considerable current interest. Atom-based electric-field sensing has practical applications in electromagnetic-field metrology and quantum control. Recent work on ion plasmas and ion imaging includes novel imaging techniques, formation of novel molecular ions, coupling to ultracold plasmas as well as Rydberg spectroscopy in the presence of ions. Atom-ion interactions have further attracted interest in quantum chemistry at ultracold temperatures, many-body dynamics, precision measurements and emerging technologies for quantum computing and simulation. While methods to harness such interactions are being investigated in the aforementioned applications, detrimental effects caused by them are also being studied.

In industrial applications, laser-cooled atoms are employed as a source of focused ion beams (FIB). Configurations based on magneto-optical trapping and on atomic beams cooled in two transverse directions have been demonstrated. These approaches present feasible alternatives to other FIB sources that include liquid-metal and gas-field ion sources as well as coupled plasma sources. Inter-particle Coulomb interactions remain a challenging aspect in cold-atom FIB sources, their applications in industry, as well as in fundamental science.

A non-invasive, integrated, in-situ atomic electric-field measurement method can be valuable to monitor and control Coulomb effects in cold-ion sources. To that end, this disclosure investigates the electric fields in ion streams prepared by quasi-continuous laser ionization of cylindrical samples of laser-cooled and -trapped Rb atoms. The samples are prepared in the focal region of a far-off-resonant optical-lattice dipole trap (OLDT) that is formed inside a near-concentric, in-vacuum resonator. Non-invasive electric-field measurement is performed by laser spectroscopy of the Stark effect of low- and high-angular momentum Rydberg atoms. Spectra are taken over a range of amplitudes of an applied ion extraction field, F. This disclosure explores how the electric-field distribution in the ion sourcing region transitions from a micro-field-dominated distribution at F=0 V/cm, which approximates a Holtsmark distribution, into a relatively narrow distribution at large-enough F. The Rydberg spectra reflect how the field F turns a Coulomb-pressure-driven, widely dispersed and largely isotropic ion stream into a directed ion beam with reduced Coulomb interactions.

This section provides background information related to the present disclosure which is not necessarily prior art.

### SUMMARY

This section provides a general summary of the disclosure, and is not a comprehensive disclosure of its full scope or all of its features.

In one aspect, a method is presented for generating an ion beam. The method includes: positioning atoms in a cavity (optical resonator) that defines an optical dipole trap; exciting the atoms while the atoms are trapped in the optical dipole trap using two or more laser beams, thereby forming ions; and driving the ions along an output axis towards a target by applying an electric field to the ions. It is envisioned that the optical dipole trap may be implemented as a running wave in a ring cavity or a two mirror cavity.

In an example embodiment, the cavity is cylindrical and the output axis is perpendicular to longitudinal axis of the cavity. The method may further include applying the electric field to the ions using electrodes arranged symmetrically and circumferentially around the cavity of the optical resonator.

In some embodiments, the method further includes acquiring an atomic excitation spectrum of atoms in the ion beam while the ion beam is being generated; and changing ion density of the ion beam based on the atomic excitation spectrum. The atomic excitation spectrum may be acquired by diagnosing the ion beam with a measurement laser and counting the excited atoms as a function of wavelength of the measurement laser. Alternatively, the atomic excitation spectrum may be acquired by determining energy level shifts of Rydberg atoms in the ion beam using electro-magnetically induced transparency.

In another aspect, the ion density of an ion source is regulated, for example using feedback control. The ion source may be regulated by generating an ion beam along an output axis towards a target using an applied electric field; acquiring an atomic excitation spectrum of atoms in the ion beam while the ion beam is being generated; and changing ion density of the ion beam based on the atomic excitation spectrum.

Changing the ion density may be achieved by inputting the atomic excitation spectrum into a feedback loop and controlling the power of the two or more laser beams with an acoustic-optic modulator and using feedback from the feedback loop.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 depicts a system for creating and regulating cold ion streams in accordance with this disclosure.

FIG. 2A is a diagram of an experimental setup employed for a laboratory demonstration of a Rydberg-monitored cold ion source.

FIG. 2B is a diagram of the utilized rubidium energy levels (not to scale).

FIG. 2C is a diagram showing the timing of amplitude control of the utilized laser pulses for the cold ion source.

FIG. 2D is a top view of the experimental setup shown in FIG. 2A.

FIG. 3 is a Stark map of 57F_{5/2} and neighboring hydrogenic states versus applied field and laser tuning in the absence of ions.

FIGS. 4A-4D are experimental Stark maps of 57F_{5/2} and neighboring hydrogenic states at the values of the ion-flux parameter γ shown.

FIGS. 4E-4G depict corresponding simulated Stark maps with empirically determined ion rates indicated on the plots. Dashed saucer-shaped areas in (a)-(c) and (e)-(g) indicate regions where the signal is small because state mixing and redistribution of oscillator strength from the 57F state to neighboring hydrogenic states is not complete. The dashed rectangles in (e)-(h) frame quasiperiodic structures that are present in the simulated results but absent in the experimental data. The short-dashed vertical bars indicate extraction fields F at which the 57F line becomes indiscernible in the signal due to mixing with hydrogenic states.

FIG. 5A is a graph showing probability density function of scaled electric field for the cases of a pure Holtsmark distribution (solid black lines) and for ion sources with simulated ion rates of R=10⁸ s⁻¹ (dash-dotted line) and R=10⁷ s⁻¹ (dashed line for F=0).

FIGS. 5B and 5C are graphs showing the probability density functions P(Enet) vs Enet and F for Rᵢₒₙ=10⁸ s⁻¹ and Rᵢₒₙ=10⁷ s⁻¹, respectively.

FIG. 6 are graphs showing experimental recordings of Stark-broadened and shifted 60P lines at different γ values.

FIGS. 7A-7D are plots of ion trajectories projected into the xy-plane for 20 μs of simulated dynamics and extraction fields F-0 in FIGS. 7A and 7B and F=0.35 V/cm in FIGS. 7C and 7D. Ions rates are R=10⁷ s⁻¹ in FIGS. 7A and 7C and R=10⁸ s⁻¹ in FIGS. 7B and 7D.

Corresponding reference numerals indicate corresponding parts throughout the several views of the drawings.

### DETAILED DESCRIPTION

Example embodiments will now be described more fully with reference to the accompanying drawings.

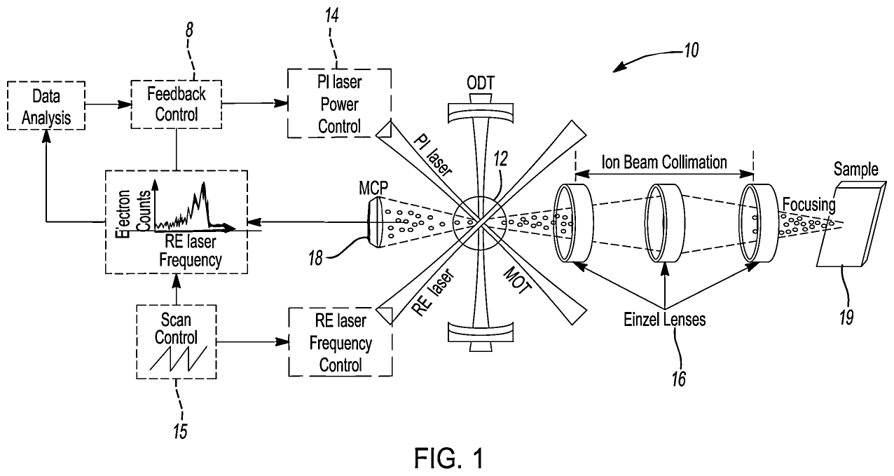

FIG. 1 depicts a system 10 for creating and regulating cold ion streams in accordance with this disclosure. The ions are generated by photoionization within a small region formed by a focused, far-off-resonance, in-vacuum dipole atom trap. In one embodiment, atoms are positioned in an optical resonator that defines an optical dipole trap 12. The dipole trap field is prepared by a defect-free mode of an in-vacuum, near-concentric optical cavity, providing an ion-source spot at the optical diffraction limit of the cavity. In one example, the optical dipole trap 12 is an optical lattice in a two-mirror cavity, such that the cavity is cylindrical and the output axis is perpendicular to longitudinal axis of the cavity. It is envisioned that the optical dipole trap 12 can take other forms, such as a running wave in a ring cavity.

During operation, the dipole trap 12 is continuously loaded with atoms from an overlapped magneto-optic trap (MOT), which laser-cools atoms from a low-pressure background vapor (e.g., less than about 10\hat{ }-7 Torr). While the atoms are trapped in the optical dipole trap 12, the atoms are excited using two or more laser beams 14, 15, thereby forming ions. The ions are in turn driven along an output axis towards a target 19 by applying an electric field to the ions. In one embodiment, the electric field is generated using electrodes arranged symmetrically and circumferentially around the longitudinal axis of the cavity.

Ions traveling along the output axis are guided towards the target 19 by electrostatic lens 16. In the example embodiment, the ions are focused on the target using Einzel lens (or unipotential lens) although other types of lens are contemplated by this disclosure. For ion sources, a high ion flux is generally desired. With increasing flux, the Coulomb interactions between the ions degrade the achievable focal spot size on the target. Hence, a compromise is made between ion flux and achievable target spot size.

In one aspect of this disclosure, the ion density of the ion beam can be regulated using feedback control 8. While an ion beam is generated by the ion source, an atomic excitation spectrum of atoms is acquired and the ion density of the ion beam is changed based on the atomic excitation spectrum. More specifically, the Coulomb electric fields in the ion source are measured in near real time using the Stark effect of Rydberg atoms embedded in the ion source, where the electric field correlates to the ion density of the ion beam. Different techniques for determining the atomic excitation spectrum are contemplated by this disclosure.

In one example, the atomic excitation spectrum is acquired by scanning the ion beam with a measurement laser and counting atoms as a function of wavelength of the measurement laser. A single electron particle counter 18, such as a channeltron or a micro-channel plate, can be used. The acquisition of the spectrum occurs concurrently with the operation of the ion source operation and does not disrupt operation. An atomic-physics module extracts electric-field distributions from the spectra that are characteristic of the ion density and other parameters of the ion source. The random micro-field level extracted from the data is entered into a feedback control loop, which regulates the ion generation rate to maintain a set level of micro-fields, which corresponds with the maximum ion flux possible under the constraint of a maximally allowed spot-size on the target.

In another example, the atomic excitation spectrum is acquired by determining energy level shifts of Rydberg atoms in the ion beam using electro-magnetically induced transparency (EIT). This alternate electric-field acquisition method is all-optical, i.e., it replaces in-vacuum single-electron particle counters with external photo-diode detectors to acquire Rydberg Stark spectra. The EIT-based method simplifies the atomic-physics component of the ion-source system 10, enabling solutions that may be more attractive.

Based on the atomic excitation spectrum, ion density of the ion source can be adjusted in different ways. For example, power of the lasers forming the atom trap can be controlled, for example with an acousto-optic modulator. Additionally or alternatively, power of the lasers that effect the photo-ionization of the trapped atoms can be controlled. Power of the repumping lasers can also be controlled, for example with an acousto-optic modulator.

In some instances, feedback control loops may involve auxiliary measurement inputs, including the electron current from the photo-ionization. One control-loop embodiment is a software-implemented PID control, where the error signal is given by the deviation of the measured micro-field level from a set micro-field level, and the loop output is an analog voltage. The loop output in turn services as a control signal, for example for the acoustic-optic modulator. The loop output voltage may have a fast-acting (high-bandwidth) channel that regulates the power of the auxiliary photo-ionization laser(s), the MOT laser or the MOT re-pumper laser power, and a slow-acting (low-bandwidth) channel that regulates the room-temperature background vapor pressure by adjusting the temperature of the rubidium or cesium reservoir that feeds the MOT region. Other elements suitable for laser-cooling and laser-trapping, photo-ionization and Rydberg-atom electric-field sensing may be used. Also, a plurality of elements serving distinct purposes may be used in one device, for instance rubidium for generation ions and cesium for Rydberg electric-field sensing.

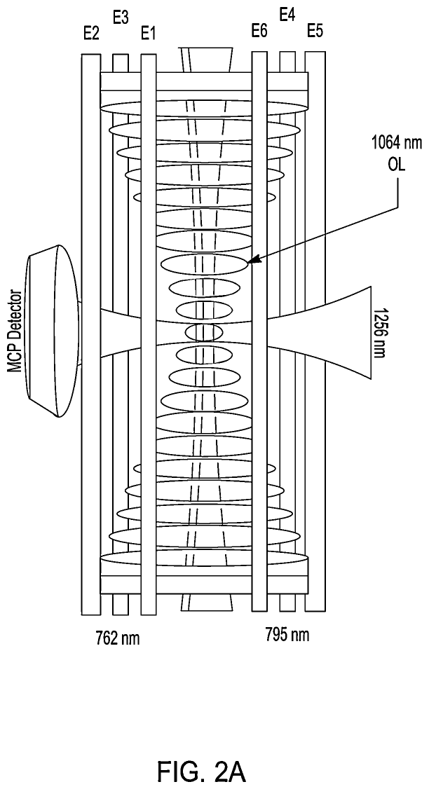

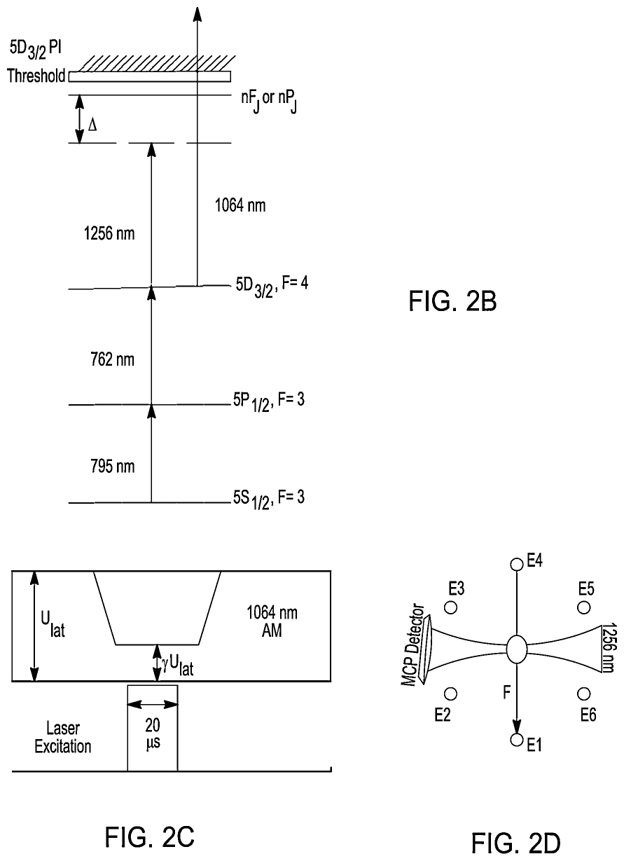

For a deeper understanding, an experimental setup for the cold ion source and the results of two sets of experiments with rubidium is further described below. To prepare and probe ion streams, a cylindrically symmetric, long and thin atom cloud is prepared in an optical-lattice dipole trap (OLDT) focus, as shown in FIG. 2. With the OLDT adiabatically lowered to less than 1% of its original depth, photoionization (PI) and Rydberg-atom excitation lasers are simultaneous turned on, creating a quasi-continuous situation in which ions are sourced at a controllable rate within the small OLDT region. The ions stream outwards due to Coulomb repulsion. Under absence of external electric fields, the ensuing quasi-continuous ion stream is cylindrically symmetric around the OLDT axis. Upon applying the external dc ion extraction field, F, the ions are extracted and form a continuous, directed ion stream with a reduced ion density and diminished effects from Coulomb repulsion. The ions in the quasi-steady-state streams are subject to a net electric field, Eₙₑₜ, which consists of F, a macroscopic, smoothly-varying field caused by the average charge density distribution, E_{mac}, and a fluctuating microscopic field E_{mic} caused by the discreteness of the ionic charges, such that

$${E}_{net} = F + {E}_{mac} + {E}_{mic} \qquad ( 1 )$$

In experiments, Rydberg atoms are excited concurrently with the ion sourcing. The objective of this study is to use Rydberg-atom Stark effects to measure the distribution of the field-magnitude, /Eₙₑₜ/, as a function of the ion source rate, Rᵢₒₙ, and the magnitude of the extraction field, F. The experimental setup shares some aspects with other hybrid systems of cold atoms and ions. Here, we aim at a spectroscopic measurement of electric fields in ion sources, and there is no ion trap involved.

FIG. 2A shows the experimental setup. Cold ⁸⁵Rb atoms are loaded from a 3D magneto-optical trap (MOT) into the OLDT of depth Uₗₐₜₜ˜h×8 MHz for 5S_{1/2}-atoms, generated by coupling 1064 nm light into a clean TEM₀₀ mode of an in-vacuum, vertically-oriented nearly-concentric optical cavity of finesse ˜600. Up to ˜10⁴ atoms are collected in the high-intensity regions of the OLDT cavity mode while the MOT is on, with cooling provided by the MOT laser field. The OLDT provides atom samples with a density≤10¹¹ cm⁻³, a diameter of ˜20 μm, and a length of ≤1 mm along the OLDT axis. After loading, Uₗₐₜₜ is adiabatically ramped down to a reduced depth of γUₗₐₜₜ by means of an acousto-optical modulator for controlled three-photon photo-ionization (PI) of atoms trapped in the OLDT, allowing one to set the ion-source rate, Rᵢₒₙ.

In the experimental setup, four lasers, including the OLDT laser, are used to generate ion streams via PI and to measure ion fields via Rydberg-atom spectroscopy, as shown in the ⁸⁵Rb level scheme in FIG. 2B. The timing of OLDT amplitude reduction and laser excitation is depicted in FIG. 2C. The MOT beams are turned off during ionization and Rydberg-atom excitation, while the MOT repumper beam is left on. The two probe lasers that drive the lower 5S_{1/2}, F=3→5P_{1/2}, F=3 (795 nm, power ˜200 nW before vacuum chamber) and the middle 5P_{1/2}, F=3→5D_{3/2}, F=4 (762 nm, power ˜1 μW before vacuum chamber) transitions are pulsed on-resonance with the respective transitions, and the laser beams are coupled through the cavity which ensures good spatial overlap with the atoms trapped in the utilized TEM₀₀ mode of the OLDT. The laser driving the atoms in the 5D_{3/2}, F=4 state to the chosen Rydberg states (1256 nm, power ˜ 15 mW before chamber) is always on, and its detuning, Δ, is scanned across the Rydberg states of interest. The 1256 nm laser is introduced from a direction perpendicular to the OLDT axis, as seen in FIGS. 2A and 2D. A cylindrical lens installed outside the vacuum system is used to shape the 1256 nm laser mode to match the OLDT waist of ≈20 μm and to cover the length of the trapped-atom cloud along the OLDT axis (≤1 mm). The frequency scans of the 1256 nm laser are calibrated by sending a beam sample through a Fabry-Perot etalon (374 MHz free spectral range), the transmission peaks of which provide frequency marks.

The OLDT cavity is surrounded by six long, thin electrodes parallel to the OLDT axis (E1 through E6 in FIG. 2). The electrodes are used to apply electric fields during ion sourcing and Rydberg-atom excitation, as well as to field-ionize the Rydberg atoms for Rydberg-atom counting after the 20 μs probe duration. During the 20 μs ion-sourcing and Rydberg probing, the electrodes E2, E3, E5 and E6 are kept at voltages that minimize dc Stark shifts of Rydberg levels, while voltages applied to the electrodes E1 and E4 are employed to apply the controllable, approximately homogeneous ion extraction field, F, within the experimental region [see FIG. 2D]. The field F, when applied, directs the ion flow in a direction transverse to the OLDT axis. The electrode arrangement allows electric-field control in the two directions transverse to the OLDT axis. In previous work using the same setup there has been no indication of stray electric-field components parallel to the OLDT axis. For field ionization (FI) of Rydberg atoms, individually-controlled high-voltage pulses are applied to electrodes E5 and E6. In contrast to previous experiments, where positive-ion detection was used, Rydberg electrons liberated by FI are detected. This modification is necessary in order to discern the spectroscopic Rydberg-atom signal from the ions generated by PI of 5D_{3/2} atoms. Small control-voltage adjustments applied to E2 and E3 steer the electrons onto a microchannel plate detector (MCP). MCP pulses are counted and recorded for processing. Rydberg spectra are obtained as a function of laser detuning, Δ, the magnitude F, and the ion source rate, Rᵢₒₙ.

After loading atoms into the OLDT, its depth is reduced from Uₗₐₜₜ≈h×8 MHz to γUₗₐₜₜ with γ≤5×10⁻³ [see FIG. 2C]. To source ion flows, we employ three-stage PI of the 5S_{1/2} atoms by the 795 nm and 762 nm lasers, which are also used for Rydberg-atom excitation, and the attenuated 1064-nm OLDT field [see FIG. 2B]. The ac light shifts of the bound atomic levels in the attenuated lattice of <100 KHz are irrelevant during the 20-μs-long ionization and Rydberg-probe phase. With the PI cross section of 5D_{3/2} at 1064-nm of ≈44 Mb and considering all three PI stages [see FIG. 2B], the PI rate in the attenuated lattice is estimated to have a maximum value of ≤5×10⁴ s⁻¹ per 5S_{1/2} atom in our experiments. For up to ˜10⁴ atoms trapped in the OLDT-mode, and assuming some inefficiency due to the beam profiles of the three PI laser beams and the atom distribution, the highest ion-source rates in this experiment are estimated Rᵢₒₙ≤5×10⁸ s⁻¹. Only at the highest ion source rates may the atom sample become slightly depleted by PI-induced atom loss. PI of the Rydberg atoms used for electric-field measurement does not play a role.

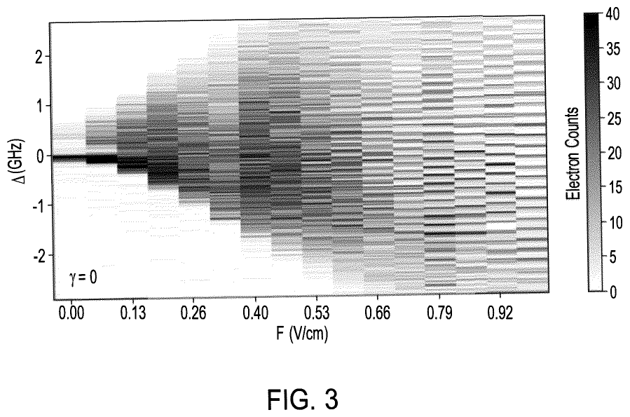

To calibrate F, a Stark map is acquired without ions near the field-free 5D_{3/2}, F=4→57F_{5/2} transition, shown in FIG. 3. The 57F-line at field F=0 V/cm defines Δ=0 MHz. In the field range 0<F≤0.1 V/cm, hydrogenic states with angular-momentum quantum number l≥4 begin to mix with 57F and generate signal at positive Δ. As the field F is increased further, the hydrogenic states spread out into both positive- and negative-Δ domains due to linear Stark effect, and the signal increasingly spreads across all Stark states due to increased state mixing with the 57F state. For electric fields F≥0.6 V/cm, the linear Stark states become well-resolved and form a periodic structure of lines. Stark maps calculated for Rb Rydberg atoms with principal quantum number n show a period of 3nea₀F (not 1.5nea₀F, as in hydrogen). Matching calculated with measured spectra, the field F is calibrated against applied voltage to an uncertainty of about 1%, which is satisfactory for the present purpose. In the presence of ion streams, the ionic macro- and micro-fields add to F according to Eq. 1. Resultant alterations in the Rydberg Stark spectra can be used to diagnose the electric fields in the ion source.

Two sets of experiments are performed: one using the 57F_{5/2} state, and the second one using the 60P_{1/2} state. Since the respective quantum defects are approximately 0.0165 and 2.65, these states are close in energy. In the first measurement we exploit the fact that the relevant Hilbert space has on the order of 100 near-degenerate states for each magnetic quantum number, my, that couple to each other in dc and in low-frequency ac fields, resulting in maximal linear Stark effect. Recently, such states have been utilized for detection of rf fields in VHF/UHF frequency ranges. In the second measurement, we use that the two magnetic sublevels, m_{J}=±1/2, of 60P_{1/2} have equal quadratic Stark shifts, allowing a straightforward extraction of electric-field distributions from spectroscopic line shapes. However, at ˜0.4 V/cm, the highest field relevant in the present work, the quadratic Stark shift of 60P_{1/2} is still smaller than linear Stark shifts of n=57 high-angular-momentum, hydrogenic Stark states by a factor of ˜40. Hence, the 60P_{1/2}-measurement loses accuracy at low fields.

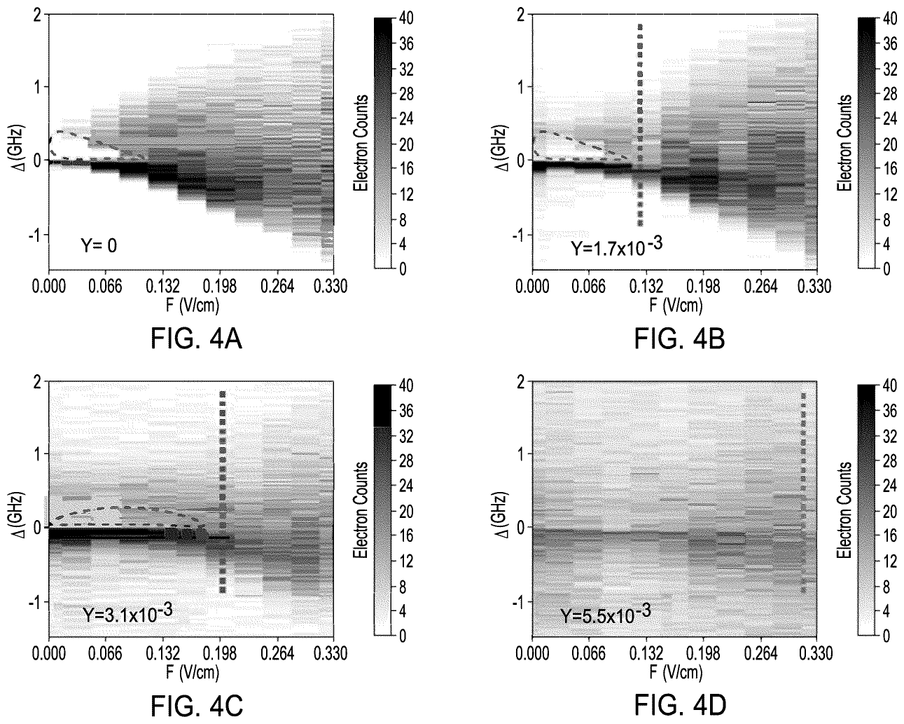

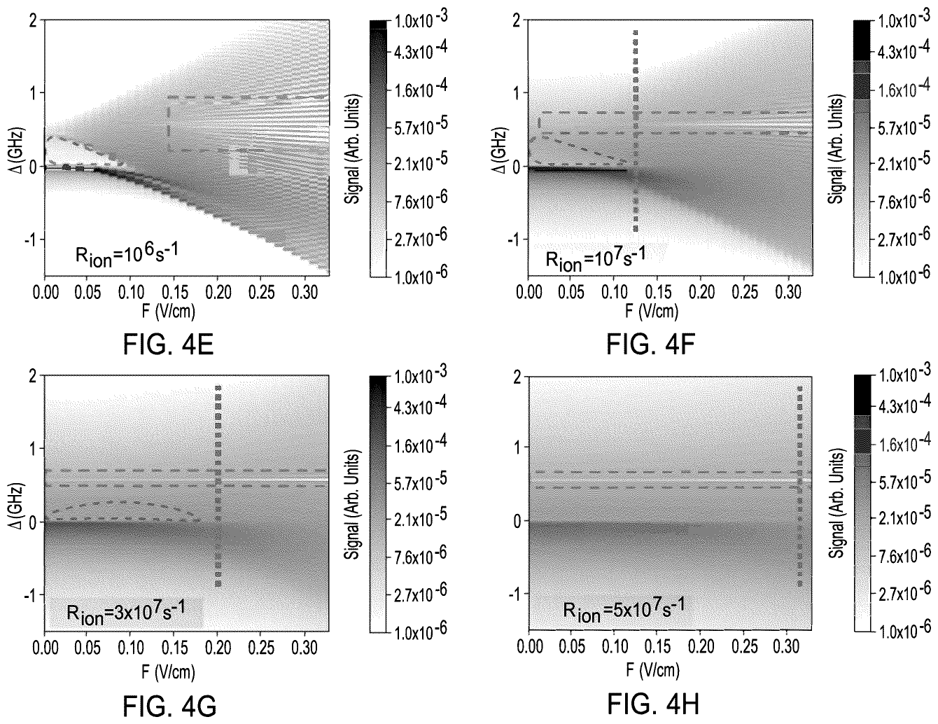

In the FIG. 4A-4D, it is shown that experimental Stark maps near 57F_{5/2} at four γ-values, and in FIGS. 4E-4G a set of matching simulations are shown. An initial examination of FIGS. 4A-4D reveals several features:

(1) With increasing γ, the hydrogenic Stark states efficiently mix with the 57F-state, causing the overall spectral distribution to cover a region of several GHz, even at extraction field F=0. At the largest γ, the spectral broadening at extraction field F=0 exceeds 2 GHz. Noting that in a net electric field, Eₙₑₜ, the largest linear Stark shifts are ≈±1.5n²ea₀Eₙₑₜ, the spectral broadening observed at the highest source rates and at F=0 allows us to conclude that the ion macro- and micro-fields, /E_{mac}+E_{mic}/, exceed a range of about 0.4 V/cm. Hence, the ionic fields exceed the applied extraction field F over a large fraction of the investigated range of F and γ.

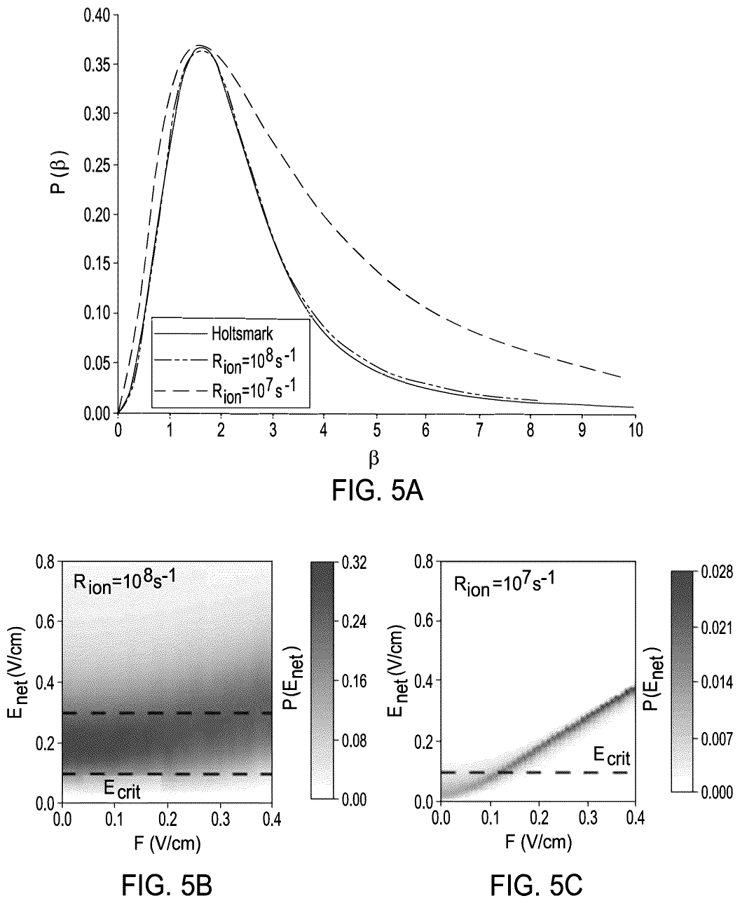

(2) At small F, the 57F-signal exhibits a sharp dropoff near Δ=0 MHz towards positive Δ. As F increases, the 57F-signal becomes diluted, redshifts and eventually blends into the overall signal. This leads to a “knee” in the signals at certain F-values. With increasing γ, the knee dims and moves to larger values of F. To explain this behavior, first note that fields Eₙₑₜ≤E_{crit}=2E_{H}δ_{f}/(3ea₀n⁵), with atomic energy unit E_{H}≈27.2 eV and f-quantum defect δ_{f}=0.0165, will not entirely mix the F-state into the manifold of hydrogenic states, resulting in a clearly visible 57F-signal near Δ=0 MHz that is slightly redshifted due to a quadratic Stark effect. Whereas, for fields Eₙₑₜ≥E_{crit}, the 57F-state becomes mixed across many linear hydrogenic states, causing the 57F-signal near Δ=0 MHz to wash out and to become indiscernible from that of the hydrogenic states. Here, E_{crit}≈0.1 V/cm (as may also be inferred from FIG. 3). The observed knee therefore occurs at extraction fields F that are sufficiently strong that the net electric-field distribution, P (Eₙₑₜ), has no significant contribution left in the range Eₙₑₜ≤E_{crit}=0.1 V/cm. The data in FIGS. 4A-4G show that, as γ increases, it takes a larger F to dilute the ion density to a degree at which the weak-field contribution, ∫₀^{˜0.1 V/cm}P (Eₙₑₜ)dEₙₑₜ, becomes insignificant. At the highest ion rates, the ionic fields broaden the distribution P (Eₙₑₜ) by enough that even at F=0.35 V/cm, the largest F studied, a substantial low-field probability Eₙₑₜ≤E_{crit}=0.1 V/cm remains. This physical scenario is confirmed by the simulated field distributions P (Eₙₑₜ) shown in FIG. 5.

(3) Related to items (1) and (2), at low γ it is observed that the combination of state mixing, Stark shifts and redistribution of oscillator strength from the 57F into the hydrogenic states leaves a region of relatively small signal, indicated by the blue-dashed saucer-shaped areas in FIGS. 4A-4G. With increasing γ the blue-dashed shapes increasingly fill in with signal and stretch to larger extraction field F, until they become unobservable above a certain γ. Following arguments given in item (2), as a threshold condition for the saucer-shaped areas to disappear one expects that γ must be large enough that at F=0 the peak of the ion-field distribution, P (Eₙₑₜ), exceeds E_{crit}=0.1 V/cm.

(4) Comparing measurements and simulations in FIGS. 4A-4G, it is seen that the experiment does not resolve the quasi-periodic structures between the dashed green lines in the simulation. The latter are due to linear Stark states with near-zero slope, equivalent to near-zero electric-dipole moment (see FIG. 3). This minor disagreement is likely caused by spectroscopic line broadening due to the MOT magnetic field (which is left on) and power broadening of the lower transitions driven by the 762-nm and 795-nm lasers. The structures between the dashed green lines could also be washed out by the inhomogeneity of the ion electric fields within the volume of individual Rydberg atoms, as one may expect from the spectra of individual Rydberg-atom-ion pairs.

To confirm our interpretation of the data presented, a detailed model is developed for the ion streams, their electric fields, and the Stark spectra that will result. In the ion-trajectory model, we assume an initial Gaussian atom density distribution with a full width at half maximum (FWHM) of 15 μm transverse to and 500 μm along the OLDT direction, an initial ion temperature of 44 mK, according to the ion recoil received in the PI, a fixed average ion rate Rᵢₒₙ, and a simulated duration of 20 μs. The ions are generated at random times between t=0 and t=20 μs and evolve under the influence of the ion extraction field, F=F\hat{x}, and the Coulomb fields of all ions. The ions give rise to both the macro- and micro-fields, E_{mac} and E_{mic}. Every 500 ns the electric-field vectors are sampled on a three-dimensional grid of 1 μm spacing in all directions, inside a tube of 10 μm radius that is centered with the ion source. The sampling volume approximates the extent of the Rydberg-atom field-sampling volume. The simulation yields the net field distribution affecting the Rydberg atoms, P (Eₙₑₜ), with Eₙₑₜ=/F+E_{mac}+E_{mic}/ (see Eq. 1), as well as maps of the electric field averaged over user-defined time intervals, [symbol] Eₙₑₜ [symbol] =F+ [symbol] E_{mac} [symbol] , maps of the root-mean-square (RMS) electric field about the average, ion-density maps, as well as sample ion trajectories for visualization. A quasi-steady-state is typically reached after 5 μs of ion sourcing. In the following, the distributions P (Eₙₑₜ) are averaged over the duration of the ionization and Rydberg field-probing pulse of 20 μs, i.e. a time considerably longer than the time needed for the system to reach a quasi-steady-state.

A bank of Stark spectra of Rydberg atoms is also computed in randomly polarized laser fields. The dc electric field applied to the atoms in the computation of the Stark maps is homogeneous and stepped in steps of 5 mV/cm from 0 to 1 V/cm. This results in 200 Stark spectra. Then one can use the electric-field distribution P (Eₙₑₜ) from the trajectory simulation as a weighting function to obtain a weighted average of Stark spectra that models the experiment. The averaged Stark spectra depend on F and the ion rate, Rᵢₒₙ, in the trajectory simulation. The Rᵢₒₙ-value is adjusted between simulation runs to arrive at a match between simulated and measured Stark spectra. The four simulation results shown in FIGS. 4E-4G are obtained for the Rᵢₒₙ-values indicated in the figure.

The agreement observed between simulation and experiment is quite satisfactory. In results not shown, it was established that the exact volume of the field sampling region does not significantly affect the results, as long as the field sampling region does not exceed the ion sourcing region. The quasi-periodic bars in the simulation at Δ˜500 MHz, which are due to Stark lines with near-zero dipole moment, are absent from the experiment. Further, the best-fitting Rᵢₒₙ tends to scale as (Uₗₐₜγ)^{k} with a κ>1. Since γ≤5×10⁻³, the degree of decompression is fairly extreme, and Rᵢₒₙ becomes reduced due to several effects. These include atom loss from the lattice, decompression-induced density reduction of the remaining trapped-atom cloud, and reduction in PI rate per atom (which is proportional to γ). The empirical finding κ>1 is therefore expected. For the experimental procedure employed to vary Rᵢₒₙ, it is only important that the function Rᵢₒₙ(γ) is smooth and homogeneous, allowing control of Rᵢₒₙ using γ as a control parameter. At the present stage of the investigation, details of the function Rᵢₒₙ(γ) are not critical.

In the following, we discuss the physical picture that arises from the simulations that have successfully reproduced the experimental data. The simulations provide us with a complete picture of the ion-stream's particle phase-space and electric-field distribution. Generally, one finds in the simulations that the ion macro-fields, E_{mac}, which are not to be confused with F, are considerably smaller than the micro-fields, E_{mic}. At Rᵢₒₙ=10⁸ s⁻¹ and F=0, E_{mac} is less than 12% of the RMS-value of the micro-fields, while at Rᵢₒₙ=10⁷ s⁻¹ and F=0 it is less than about 5%. Hence, the dominant ion-field effects are from the micro-fields.

First, we examine how close the electric-field distribution in the ion-source region can come to an ideal Holtsmark distribution, P_{H} (Eₙₑₜ), for which F=E_{mac}=0 in Eq. 1. The idealized micro-field distribution in cases of negligible external and macro-field, P_{H}(Eₙₑₜ), is given by the Holtsmark function, which has been widely utilized in the context of plasma physics, field sensing and astrophysics. The Holtsmark distribution has the form:

$${P}_{H} ( {E}_{net} ) = \frac{2}{π} \frac{{E}_{net}}{{E}^{2}} {\int }_{0}^{∞} dx x sin ( \frac{{E}_{net}}{E} x ) exp ( - {x}^{3 / 2} ) \qquad ( 2 )$$

The electric-field scale parameter, \tilde{E}, is related to the ion density, ρᵢₒₙ, as:

$$\tilde{E} = \frac{e}{{2}_{{ε}_{0}}} {( \frac{4}{15} {ρ}_{ion} )}^{2 / 3} \qquad ( 3 )$$

where e is the electron charge and ε₀ the vacuum electric permittivity. The function P_{H}(Eₙₑₜ) peaks at Eₙₑₜ≈1.61\tilde{E} and has an average field of about 2.9\tilde{E}. Due to the quadrupolar character of the electric field near random field zeros between ions, the low-field scaling behavior of P_{H} is ∝Eₙₑₜ.

In FIG. 5, the ideal Holtsmark distribution is compared with simulated electric-field distributions in the ion source, P(Eₙₑₜ/\tilde{E})=:P(β) for F=0, with the scaling fields \tilde{E} empirically adjusted to match the peaks of the simulated distributions with that of the Holtsmark distribution. It is seen that for Rᵢₒₙ=10⁸ s⁻¹, the electric field follows a distribution that almost perfectly matches a Holtsmark distribution. Using the ion density ρᵢₒₙ from the simulation, averaged over a cylinder of 10 μm radius and 200 μm length, from Eq. 3 compute a scaling field \tilde{E}=0.15 V/cm, whereas the empirical scaling field that yields the best match in FIG. 5 is ≈0.12 V/cm. This is attributed to the mild deviation to the finite extent of the ion distribution, which has a simulated full width at half maximum (FWHM) diameter of the ion density of 25 μm and a Wigner-Seitz (WS) radius of 9.8 μm. Since the ratio between FWHM diameter and WS radius is only 2.5, a small deviation between the ideal and empirical scaling fields E is expected.

In FIG. 5, a result for Rᵢₒₙ=10⁷ s⁻¹ is also shown which is at the lower end of ion rates studied. In that case, the simulated scaled-electric-field distribution is nearly a factor of two wider than the Holtsmark distribution, which is attributed to fact that the WS radius (17 μm) is almost as large as the FWHM diameter of the ion density. Hence, the ion distribution tends to become one-dimensional along the OLDT axis, leading to the observed relative overabundance of stronger fields. Another consequence of the larger WS radius is that the empirical scaling field that yields the best peak match, displayed in FIG. 5, is only ≈0.02 V/cm, while Eq. 3 yields \tilde{E}=0.05 V/cm, for the simulated ion density at Rᵢₒₙ=10⁷ s⁻¹. The simulated field distribution at very low net fields still is ∝Eₙₑₜ². This is expected because the electric-field character near the accidental field-zeros between ions remains quadrupolar, regardless of detailed parameters.

In the top inset of FIG. 5, P (Eₙₑₜ) is displayed for Rᵢₒₙ=10⁸ s⁻¹ and F ranging from 0 to 0.4 V/cm. It is seen that the response of the ion source to F picks up very slowly, as F is increased. Even at the largest F there remains significant net probability for Eₙₑₜ<E_{crit}=0.1 V/cm; also, there is substantial probability for fields Eₙₑₜ≥0.3 V/cm across the entire range of F. The features accord with the Stark spectra at the highest source rate in FIG. 4, where the 57F signal drop-off near Δ=0 MHz persists throughout the F-range, which is indicative of fields Eₙₑₜ<E_{crit}=0.1 V/cm. Also, the Stark spectrum is broadened beyond a range of 2 GHz for all F, which is indicative of substantial probability for fields Eₙₑₜ>0.3 V/cm. Finally, P (Eₙₑₜ) peaks well above 0.1 V/cm across the entire F-range, which is consistent with the absence of any saucer-shaped signal-depression regions in FIGS. 4D and 4H. It is noteworthy that at F=0.35 V/cm the distribution P (Eₙₑₜ) in FIG. 5 peaks visibly below F. This partial shielding of F within the field-sensing volume is caused by a counter-field on the order of 0.1 V/cm, pointing along −\hat{x}, that the stream of extracted ions creates at the location of the Rydberg atoms. This counter-field is the most significant ionic macro-field effect seen in the present work.

As seen in lower inset of FIG. 5, at Rᵢₒₙ=10⁷, s⁻¹ the field distribution, measured on an absolute field scale, is much narrower than that at Rᵢₒₙ=10⁸ s⁻¹. Due to its reduced field-shielding and Coulomb effects, the weak ion source responds quickly as F is increased. As a consequence, the field distribution narrows down and peaks up near the value of F already when F≥0.1 V/cm. The absence of fields Eₙₑₜ<0.1 V/cm in the range F≥0.15 V/cm accords with the “knee” location observed in FIG. 4B. It is also seen that the peak of P (Eₙₑₜ) is well below 0.1 V/cm at F=0 V/cm and moves past 0.1 V/cm at F≥0.1 V/cm. This causes the saucer-shaped regions of low signal in FIGS. 4B and 4F that stretch out to F=0.1 V/cm.

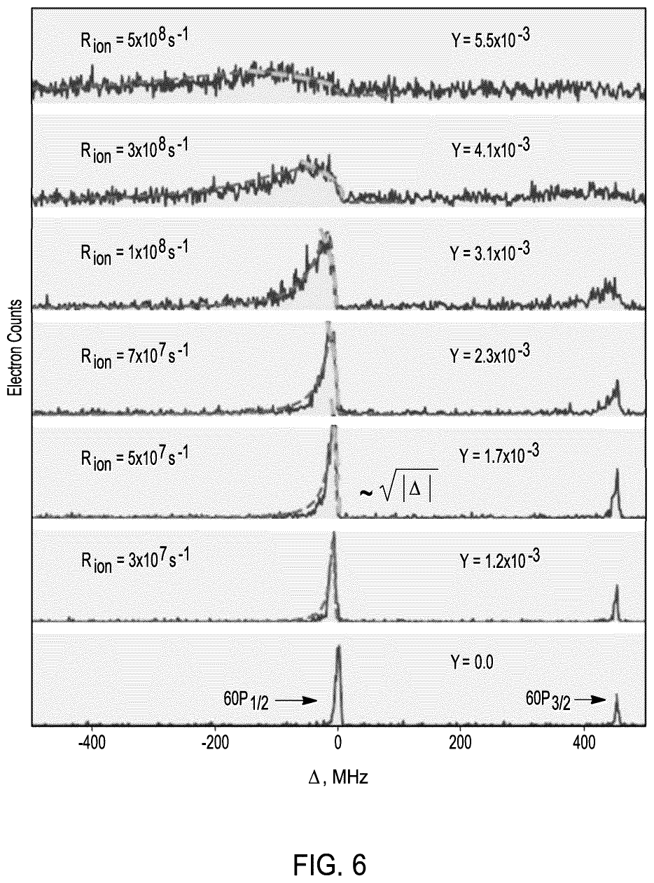

Next, results obtained from measurements using 60P; levels, which exhibit quadratic Stark shifts in weak electric fields, are described. The timing of the OLDT amplitude reduction and the laser excitation is the same as in FIG. 2C. We increase the power of the 762 nm laser for better signal-to-noise; the increased 762 nm-laser power also leads to larger values of Rᵢₒₙ. 60Pⱼ—spectra taken at a set of γ-values and F=0 are shown in FIG. 6. The fine structure of the 60P state is well-resolved. The laser detuning Δ is referenced to the transition |5D_{3/2}, F=4 [symbol] →|60P_{1/2} [symbol] in the absence of ions. The stronger fine-structure component, 60P_{1/2}, has a polarizability α=1122 MHz/(V/cm)², the polarizabilities of the mⱼ components of 60P_{3/2} are 1353 MHz/(V/cm)² and 1139 MHz/(V/cm)². Denoting the level shift with Δ=−αE²/2, an electric-field distribution P (Eₙₑₜ) maps into a distribution of 60P_{1/2}-shifts given by

$${P}_{Δ} ( Δ ) = P ( {E}_{net} = \sqrt{\vert 2 Δ / α \vert} ) / \sqrt{\vert 2 Δ / α \vert} \qquad ( 4 )$$

For micro-field distributions that scale as Eₙₑₜ² at small field, the distribution of shifts at small Δ scales as P_{Δ}α\sqrt{|Δ|}. The observed line shapes, \tilde{P}_{Δ}(Δ), are given by the convolution of P_{Δ}(Δ) with the field-free Rydberg line shape g(δ), which is taken to be a Gaussian with a FWHM of 5 MHZ, according to the experimentally observed linewidths at F=0 and low atom density,

$${\tilde{P}}_{Δ} ( Δ ) = \int {P}_{Δ} ( Δ - δ ) g ( δ ) d δ . \qquad ( 5 )$$

As seen in FIG. 6, near-symmetric initial spectra at γ=0 evolve into highly asymmetric lines with extended red tails at increasing γ. The lower fine-structure component maintains sufficient signal to noise to allow for line-shape analysis over most of the γ-range studied. For γ≥2.3×10⁻³ the line shift becomes large enough that the convolution with the line shape becomes a minor effect, and the electric-field distribution

$$P ( {E}_{net} ) \approx {\tilde{P}}_{Δ} ( Δ = - α {E}_{net}^{2} / 2 ) \vert α {E}_{net} \vert , \qquad ( 6 )$$

allowing, in principle, a direct extraction of the electric field distribution from the experimental data. Some improvement at low γ may be achieved by de-convolution of \tilde{P}_{Δ}(Δ) using the known g(δ). At γ=5.5×10⁻³ the 60P_{1/2} component is broadened over several 100 MHZ, and the 60P_{3/2} component is barely visible above the background signal.

In the ion trajectory simulation, we empirically vary the ion rate Rᵢₒₙ, extract the field distributions P (Eₙₑₜ), and compute line profiles according to Eqs. 4 and 5. Rᵢₒₙ is varied until a good match is achieved. As seen in FIG. 6, the empirical fits agree well with the experimental data, on an accuracy scale limited by experimental signal to noise.

A characteristic and easy-to-check discriminator of micro-field-dominant distributions against distributions in approximately homogeneous fields is the low-field behavior, which sales as P(Eₙₑₜ)˜Eₙₑₜ² in micro-fields, whereas in distributions in approximately homogenous fields there are no small fields. For lines with quadratic Start shifts, micro-fields generate a line profile α\sqrt{|Δ|}, whereas inhomogeneously broadened applied fields would shift the entire line and leave no signal near the original line position. In FIG. 6, on the blue sides of the spectral lines one observes relatively sharp drop-offs that terminate at the field-free line position across the entire range of γ. This observation is consistent with line-shift distributions that scale α\sqrt{|Δ|} at small Δ. To emphasize the small-shift scaling, in FIG. 6 exact square-root functions are overlaid with the blue sides of the field-shifted lines. Within the accuracy of our experiment, it is seen that the small-shift scalings follow a square-root behavior, indicating micro-field dominance.

From the discussion above, Rydberg-atom-based electric-field sensing is well-suited to acquire information on the electric-field distribution in ion sources originating from PI of dense, laser-cooled atom clouds in optical dipole traps. It was also seen that in the highest-flux cases studied the electric-field distribution in the ion sourcing region approaches that of an ideal Holtsmark distribution.

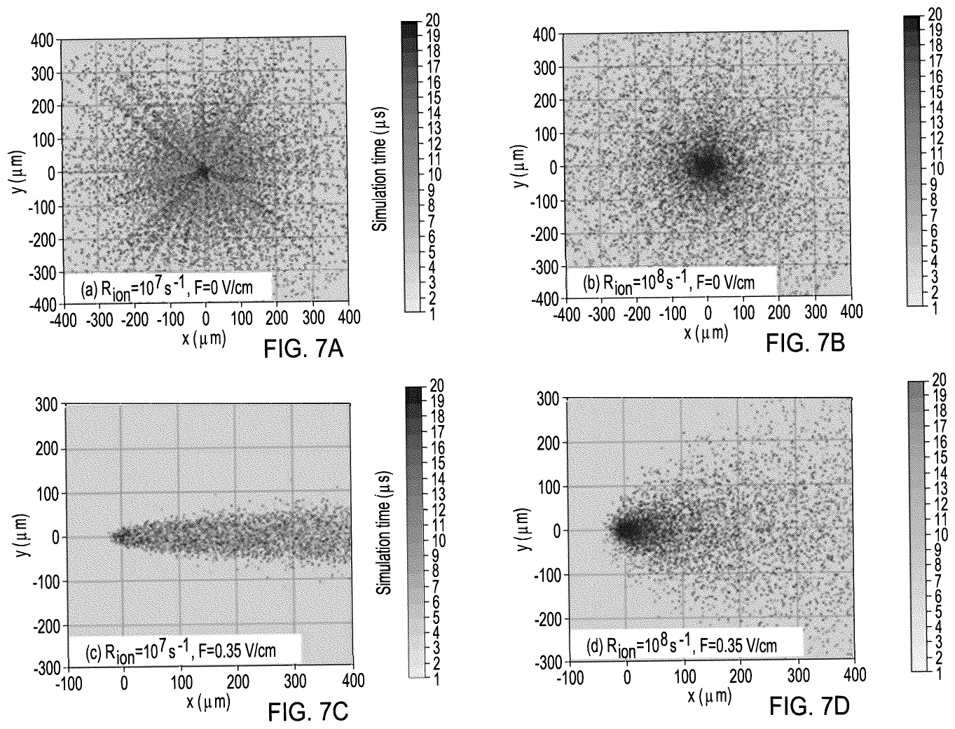

To further discuss the suitability of the presented setup to source and monitor ion streams, images of ion stream are presented at the lower and upper end of the experimentally covered flux regime, obtained from ion trajectory simulations at Rᵢₒₙ=10⁷ s⁻¹ and 10⁸ s⁻¹, respectively, for extraction fields F=0 and F=0.35 V/cm. The images in FIGS. 7A and 7B visualize that at F=0 a larger Rᵢₒₙ results in a more spread-out steady-state ion distribution than a low Rᵢₒₙ. More importantly, at F=0.35 V/cm the directivity and spread of the extracted ion flow degrade considerably from low to high Rᵢₒₙ, as seen in FIGS. 7C and 7D. FIGS. 4 and 6 above show that these cases result in qualitatively different spectral profiles of Rydberg-atom lines. As an instance of a basic interpretation of the spectra, the vertical dashed bars in FIG. 4 mark the Rᵢₒₙ-dependent fields F at which the 57F-line dissipates. At these fields the micro-field dominance in the ion source wanes, the ion streams become directional, and the degradation due to micro-fields subsides. As such, it is seen that Rydberg-atom spectroscopy is well-suited to characterize ion streams derived from PI of localized cold-atom sources.

Finally one can consider how close the investigated quasi-steady-state ion streams are to a plasma state, as this will have a bearing on how fluctuations in the ion sourcing might propagate through the ion streams in the form of waves. For an initial estimation, we have computed temperatures, Tᵢₒₙ, densities, pᵢₒₙ, and Debye shielding lengths, λ_{D}, from averages taken over tubes of 10 μm radius and 200 μm length, for F=0 and Rᵢₒₙ ranging from 400 mK to 1.2 K, pᵢₒₙ from 4.7×10⁷ cm⁻³ to 6.4×10⁸ cm⁻³, and λ_{D} from 6.3 μm to 3 μm. Over the entire range, Tᵢₒₙ substantially exceeds the initial ion temperature from PI of 44 mK due to continuous Coulomb effects. As expected, the temperature increases with Rᵢₒₙ. Over the Rᵢₒₙ-increase of a factor of 40, the ion density pᵢₒₙ increases only by about a factor of 14, which also reflects the increasing importance of continuous Coulomb expansion with increasing Rᵢₒₙ. As a combination of the trends in Tᵢₒₙ and ρᵢₒₙ, the Debye length λ_{D} drops by only about a factor of 2 over the entire Rᵢₒₙ increases the system transitions form a marginally plasma-like state into a state that appears to be more solidly in the plasma regime.

It follows that at the higher ion rates Rᵢₒₙ studied in this disclosure the system may exhibit plasma characteristics, such as a collective wave-like response in ion-flow behavior caused, for instance, by variations in the ion pump rate. This assessment is strengthened by estimates of the ion sound speed, vₛ, the ion plasma frequency, fᵢₒₙ, and the ion response time for disorder-induced heating, 1/(4fᵢₒₙ). For Rᵢₒₙ ranging from 1×10⁷ s⁻¹ to 4×10⁸ s⁻¹ and F=0, the respective values are estimated to range from 10 to 20 m/s, 150 to 500 kHz, and 1.6 to 0.5 μs. The heating time 1/(4fᵢₒₙ) can be compared with the time it takes for an ion to traverse the 25-μm FWHM of the ion-density distribution, which is about 3 μs. As the system is in a dynamic steady-state flow, the spatial dependence of vₛ, the ion-stream speed, fᵢₒₙ etc. will affect collective propagation phenomena, such as ion-acoustic waves, shock fronts etc. through the ion streams.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for generating an ion beam, comprising:
positioning atoms in a cavity of an optical resonator that defines an optical dipole trap, where the atoms collect at a waist of light confided in the optical resonator;
exciting the atoms while the atoms are trapped in the optical dipole trap using two or more laser beams, thereby forming ions; and
driving the ions along an output axis towards a target by applying an electric field to the ions.

2. The method of claim 1 wherein the optical dipole trap is a running wave in a ring cavity.

3. The method of claim 1 wherein the optical dipole trap is a two mirror cavity.

4. The method of claim 1 wherein the cavity is cylindrical and the output axis is perpendicular to longitudinal axis of the cavity.

5. The method of claim 4 further comprises applying the electric field using electrodes arranged symmetrically and circumferentially around the cavity of the optical resonator.

6. The method of claim 1 further comprises acquiring an atomic excitation spectrum of atoms in the ion beam while the ion beam is being generated; and changing ion density of the ion beam based on the atomic excitation spectrum.

7. The method of claim 6 wherein acquiring an atomic excitation spectrum further comprises diagnosing the ion beam with a measurement laser, and counting the excited atoms as a function of wavelength of the measurement laser.

8. The method of claim 6 wherein acquiring an atomic excitation spectrum further comprises determining energy level shifts of Rydberg atoms in the ion beam using electro-magnetically induced transparency.

9. The method of claim 6 wherein changing the ion density includes inputting the atomic excitation spectrum into a feedback loop and controlling the power of the two or more laser beams with an acoustic-optic modulator and using feedback from the feedback loop.

10. A method for regulating ion density of an ion source, comprising:
generating an ion beam along an output axis towards a target using an applied electric field;
acquiring an atomic excitation spectrum of atoms in the ion beam while the ion beam is being generated; and
changing ion density of the ion beam based on the atomic excitation spectrum.

11. The method of claim 10 wherein generating an ion beam includes:
positioning atoms in a cavity of an optical resonator that defines an optical dipole trap;
exciting the atoms while the atoms are trapped in the optical dipole trap using two or more laser beams, thereby forming ions; and
driving the ions along an output axis towards a target by applying the electric field to the ions.

12. The method of claim 11 wherein acquiring an atomic excitation spectrum further comprises diagnosing the ion beam with a measurement laser, and counting atoms as a function of wavelength of the measurement laser.

13. The method of claim 11 wherein acquiring an atomic excitation spectrum further comprises determining energy level shifts of Rydberg atoms in the ion beam using electro-magnetically induced transparency.

14. The method of claim 10 wherein changing ion density of the ion beam includes inputting the atomic excitation spectrum into a feedback control loop, and controlling the power of the two or more laser beams with an acoustic-optic modulator and using feedback from the feedback control loop.

15. The method of claim 14 wherein the feedback control loop is implemented by a proportional-integral-derivative controller.

16. The method of claim 10 wherein changing ion density of the ion beam includes closed-loop feedback control using an ion density value obtained from atomic spectroscopy.
